(19) United States
(12) Patent Application Publication
(10) Pub. No.: US 2007/0195054 A1
(43) Pub. Date: Aug. 23, 2007

(54) SOURCE DRIVER CIRCUIT FOR CONTROLLING SLEW RATE ACCORDING TO FRAME FREQUENCY AND METHOD OF CONTROLLING SLEW RATE ACCORDING TO FRAME FREQUENCY IN THE SOURCE DRIVER CIRCUIT

(76) Inventor: Hyeok-chul Kwon, Yongin-si (KR)

Correspondence Address: F. CHAU & ASSOCIATES, LLC, 130 WOODBURY ROAD, WOODBURY, NY, 11797, US

(21) Appl. No.: 11/675,109

(22) Filed: Feb. 15, 2007

(30) Foreign Application Priority Data
Feb. 22, 2006 (KR) 10-2006-0017307

(51) Int. Cl. G09G 3/36

(52) U.S. Cl. 345/100

(57) ABSTRACT

A source driver circuit in which a slow rate is adjusted according to a frame frequency and a method for adjusting a slew rate according to a frame frequency in the source driver circuit, wherein the source driver circuit includes a plurality of driver amplifiers, a frequency-current converting unit, and a bias current outputting unit. The driver amplifiers receive input voltages, generate output voltages, and adjust slew rates of the output voltages according to an amount of a bias current. The frequency-current converting unit receives a frame frequency and outputs a control current having an amount of the control current adjusted according to the frame frequency. The bias current outputting unit adjusts an amount of a bias current according to the amount of the control current and outputs the adjusted bias current to the driver amplifiers. Therefore, in the source driver circuit and the method for controlling the slew rate in the source driver circuit, by adjusting a slew rate of an output voltage of a driver amplifier according to a frame frequency, it is possible to reduce power consumption while ensuring a time required for displaying gradation data.

### CROSS-REFERENCE TO RELATED PATENT APPLICATION

This application claims the benefit of Korean Patent Application No. 10-2006-0017307 filed on Feb. 22 2006, in the Korean Intellectual Property Office, the disclosure of which is incorporated herein in its entirety by reference.

### BACKGROUND OF THE INVENTION

1. Technical Field

The present disclosure relates to a source driver circuit of a liquid crystal display apparatus and a method of controlling a slew rate in the source driver circuit and, more particularly, to a source driver circuit for controlling a slew rate according to a frame frequency and a method of controlling a slew rate according to a frame frequency in the source driver circuit.

2. Discussion of Related Art

FIG. 1 is a view schematically showing a known thin-film transistor liquid crystal display (TFT-LCD) 100.

Referring to FIG. 1, the TFT-LCD 100 generally includes a display panel 110, a gate driver circuit 120, and a source driver circuit 200.

The display panel 110 includes a plurality of liquid crystal cells 111. The display panel 110 can be modeled in a structure where a plurality of liquid crystal cells 111 are horizontally arranged by the number of channels and vertically arranged by the number of lines.

Each liquid crystal cell 111 includes a liquid crystal capacitor CL, a storage capacitor CST, and a switch SWMOS. A first terminal of the liquid crystal capacitor CL is connected to the corresponding switch SWMOS. The switch SWMOS may be an MOS transistor. An output voltage of the gate driver circuit 120 is applied to the gate of the MOS transistor SWMOS. The gate driver circuit 120 functions to turn on/off the gate of the switch SWMOS. The source driver circuit 200 outputs a gradation voltage or a gray scale voltage corresponding to display data to the liquid crystal cells of the display panel 110.

If switches SWMOS on a specific line are turned on by the output voltage 10 of the gate driver circuit 120, the gradation voltage output from the source driver circuit 200 is applied to the liquid crystal capacitors CL connected to the turned-on switches SWMOS. The storage capacitor CST is used to reduce leakage current that can be present in the liquid crystal cell 111.

The source driver circuit 200 includes a plurality of driver amplifiers 200_1 through 200_{—}n. The driver amplifiers 200_1 through 200_{—}n generate an output voltage for actually operating the liquid crystal cells. A stew rate of the output voltage of the driver amplifiers 200_1 through 200_{—}n can be expressed by Equation 1.

SR=IB/CC, (1)

where SR denotes the slew rate of the driver amplifiers 200_1 through 200_{—}n, IB denotes a bias current, and CC denotes capacitance of a compensation capacitor. If a slew rate of an output voltage of the driver amplifier 200_1 is large, a bias current IB flowing through the driver amplifier 200_1 increases. Accordingly, a problem exists that power consumption of the TFT_LCD 100 increases.

On the other hand, if the slew rate of the output voltage of the driver amplifier 200_1 is small, the gradation data cannot be normally displayed on the liquid crystal. More specifically, the liquid crystal capacitor CL is charged according to the output voltage of the driver amplifier 200_1 and gradation data corresponding to the amplitude of the charged voltage is displayed on the liquid crystal panel 110. Also, the gradation data must be displayed for a predetermined period while changing to display the next image data.

Therefore, in order to normally display gradation data, a voltage corresponding to the amplitude of the output voltage must be applied to the liquid crystal capacitor CL within the predetermined period. That is, a rising time of a voltage applied to the liquid crystal capacitor CL must be shorter than a period (the predetermined period) for which gradation data is displayed.

If the slew rate of the output voltage of the driver amplifier 200_1 is small, however, a rising time of a voltage applied to the liquid crystal capacitor CL increases. In this case, a voltage corresponding to the amplitude of the output voltage is not supplied to the liquid crystal capacitor CL within the period for which the gradation data is displayed and, accordingly, the gradation data cannot be normally displayed.

Therefore, it is necessary to appropriately set a slew rate of an output voltage of a driver amplifier and to consider a relationship between a power consumption r of a liquid crystal display apparatus and a stable display of gradation data.

### SUMMARY OF THE INVENTION

Exemplary embodiments of the present invention provide a source driver circuit for controlling a slew rate according to a frame frequency.

Exemplary embodiments of the present invention also provide a method of controlling a slew rate according to a frame frequency in a source driver circuit.

According to an exemplary embodiment of the present invention, there is provided a source driver circuit including a plurality of driver amplifiers, a frequency-current converting unit, and a bias current outputting unit.

The plurality of driver amplifiers receive a respective plurality of input voltages, generate a respective plurality of output voltages, and adjust slew rates of the output voltages according to an amount of a bias current. The frequency-current converting unit receives a frame frequency and outputs a control current in an amount that is adjusted according to the frame frequency. The bias current outputting unit adjusts the amount of the bias current according to the amount of the control current and outputs the bias current to the plurality of driver amplifiers.

The frequency-current converting unit includes a frequency-voltage converter and a voltage-current converter. The frequency-voltage converter converts the frame frequency into a voltage, outputs the converted voltage as a control voltage and adjusts and outputs an amplitude of the control voltage according to the frame frequency. The voltage-current converter converts the control voltage into a current, outputs the current as the control current, and adjusts and outputs an amount of the control current according to an amplitude of the control voltage.

The source driver circuit can further include a frame frequency outputting unit outputting the frame frequency.

The source driver circuit can also include an oscillator outputting an oscillator clock signal, in this exemplary embodiment, the frame frequency outputting unit outputs the frame frequency in response to the oscillator clock signal.

The frame frequency outputting unit can further include a counter. The counter receives a vertical synchronization signal and the oscillator clock signals counts the number of clocks of the oscillator clock signal included in one clock period of the vertical synchronization signal, and outputs the frame frequency. The source driver circuit can be included in a CPU interface. The source driver circuit can receive the frame frequency from the outside. The source driver circuit can be included in an RGB interface.

The source driver circuit can further include a frequency comparator. The frequency comparator outputs a frequency difference between the actual frame frequency and a reference frame frequency. The frequency-current converting unit outputs a control current that is changed in amount according to the frequency difference. The bias current outputting unit sums a reference bias current with the control current and outputs the summed result as the bias current.

The bias current outputting unit sums the reference bias current with the control current and outputs the summed result as the bias current if the actual frame frequency is greater than the reference frame frequency. If the actual frame frequency is less than the reference frame frequency the bias current outputting unit subtracts the control current from the reference bias current and outputs the subtracted result as the bias current.

According to an exemplary embodiment of the present invention, there is provided a method for controlling a slew rate in a source driver circuit, including; outputting a control current, outputting a bias current, and adjusting a stew rate of an output voltage of a driver amplifier. In the step of outputting the control current, a frame frequency is received and a control current in an amount that is adjusted according to the frame frequency is output. In the step of outputting the bias currents an amount of bias current is adjusted according to the amount of the control current, and the bias current is output. In the step of adjusting the is slew rate of the output voltage of the driver amplifier, the slew rate of the output voltage of the driver amplifier is adjusted according to the amount of the bias current.

The step of outputting the control current includes converting the frame frequency into a voltages outputting the voltage as a control voltage, and adjusting and outputting an amplitude of the control voltage according to the frame frequency; and converting the control voltage into a current, outputting the current as the control current, and adjusting and outputting the amount of the control current according to the amplitude of the control voltage.

### BRIEF DESCRIPTION OF THE DRAWINGS

Exemplary embodiments of the present invention will be understood in more detail from the following descriptions taken in conjunction with the attached drawings, in which:

FIG. 1 is a view schematically showing a known thin-film transistor liquid crystal display (TFT-LCD);

FIG. 2 is a block diagram of a source driver circuit in which a slew rate is controlled according to a frame frequency, according to an exemplary embodiment of the present invention; and

FIG. 3 is a circuit diagram in which a driver amplifier of FIG. 2 and a liquid crystal cell of a display panel are modeled;

FIG. 4 shows timing diagrams illustrating voltage waveforms at points A and B of FIG. 3; and

FIG. 5 is a flowchart illustrating a method for controlling a slew rate according to a frame frequency in a source driver circuit, according to an exemplary embodiment of the present invention.

### DETAILED DESCRIPTION OF EXEMPLARY EMBODIMENTS

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the present invention with reference to the attached drawings. Like reference numerals in the drawings denote like elements.

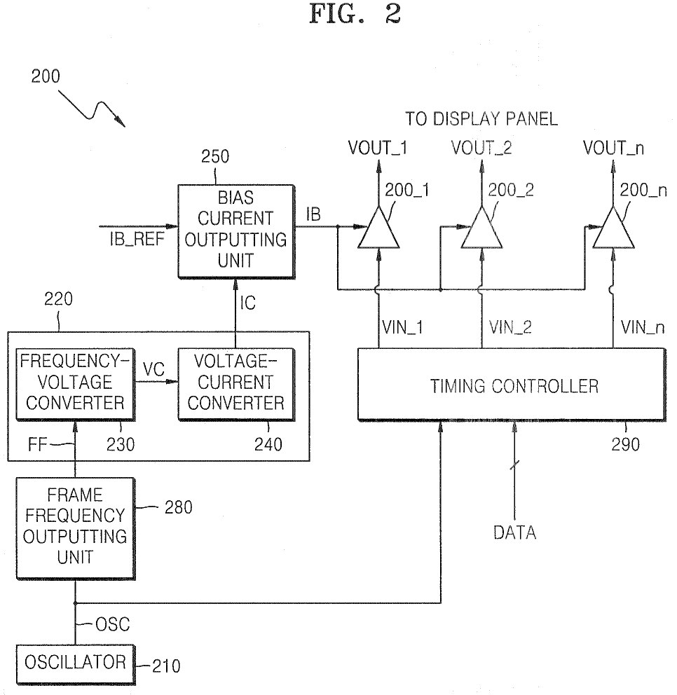

FIG. 2 is a block diagram of a source driver circuit 200 in which a slew rate is controlled according to a frame frequency, according to an exemplary embodiment of the present invention.

Referring to FIG. 2, the source driver circuit 200 includes a plurality of driver amplifiers 200_1 through 200_{—}n, a frequency-current converting unit 220, and a bias current outputting unit 250. The driver amplifiers 200_1 through 200_{—}n receive input voltages VIN_1 through VIN_{—}n and generate output voltages VOUT_1 through VOUT_{—}n, respectively.

Slew rates of the output voltages VOUT_1 through VOUT_{—}n are controlled according to an amount of a bias current IB. The frequency-current converting unit 220 receives a frame frequency FF and outputs a control current IC having an amount of a control current adjusted according to the frame frequency. The bias current outputting unit 250 adjusts the amount of the bias current IB according to the control current IC and outputs the adjusted bias current IB to the driver amplifiers 200_1 through 200_{—}n.

The frequency-current converting unit 220 can include a frequency-voltage converter 230 and a voltage-current converter 240. The frequency-voltage converter 230 converts the frame frequency FF into a voltage and outputs the voltage as a control voltage VC. The amplitude of the control voltage VC is controlled according to the frame frequency FE. The voltage-current converting unit 240 converts the control voltage VC into a current and outputs the current as a control current IC. The amount of the control current IC is controlled according to the amplitude of the control voltage VC.

When the source driver circuit 200 is connected to a CPU interface (not shown), the source driver circuit 200 can further include a frame frequency outputting unit 280 and an oscillator 210. The oscillator 210 outputs an oscillator clock signal OSC. The frame frequency outputting unit 280 outputs the frame frequency FE in response to the oscillator clock signal OSC. More specifically, the CPU interface does not receive a variety of control signals, such as a vertical synchronization signal, from the outside. Therefore, when the source driver circuit 200 is connected to a CPU interface, the source driver circuit 200 generates a vertical synchronization signal from the oscillator clock signal 05C output from the oscillator 210. Then, the frame frequency outputting unit 280 measures and outputs the frame frequency FF based on the vertical synchronization signal.

The frame frequency outputting unit 280 can include a counter (not shown). The counter receives the vertical synchronization signal generated in the source driver circuit 200 and the oscillator clock signal OSC output from the oscillator 210. The counter counts the number of clocks of the oscillator clock signal OSC included in one clock period of the vertical synchronization signal, thereby outputting the frame frequency FF.

When the source driver circuit 200 is connected to a RGB interface (not shown), the source driver circuit 200 can receive a frame frequency from the outside. That is, the ROB interface receives a variety of control signals, such as a vertical synchronization signal, from the outside. Therefore, when the source driver circuit 200 is connected to a RGB interface, the source driver circuit 200 can measure and output the frame frequency FF using a vertical synchronization signal received from the outside.

The source driver circuit 200 can further include a frequency comparator (not shown). The frequency comparator outputs a frequency difference between the frame frequency FF and a reference frame frequency. In this exemplary embodiment, the frequency-current converting unit 220 outputs the control current IC having an amount that is changed according to the frequency difference. The bias current outputting unit 250 sums the reference bias current IB-REF with the control current IC and outputs the summed result as the bias current IB.

More specifically, if the frame frequency FF is greater than the reference is frame frequency, the bias current outputting unit 250 may add the control current IC to the reference bias current IB_REF and may output the added result as the bias current IB. On the other hand, if the frame frequency FF is less than the reference frame frequency, the bias current outputting unit 250 may subtract the control current IC from the reference bias current IB_REF, and may output the subtracted result as the bias current IB.

In the above-described exemplary embodiment, when the source driver circuit 200 is connected to the CPU interface or the RGB interface, the configuration and operation of the source driver circuit 200 are as described. The configuration and operation of the source driver circuit 200 can be applied, however, regardless of the type of an interface connected thereto. For example, even when the source driver circuit 200 is connected to an RGB interface, the source driver circuit 200 can generate a vertical synchronization signal from the oscillator clock signal OSC and measure and use the frame frequency FF.

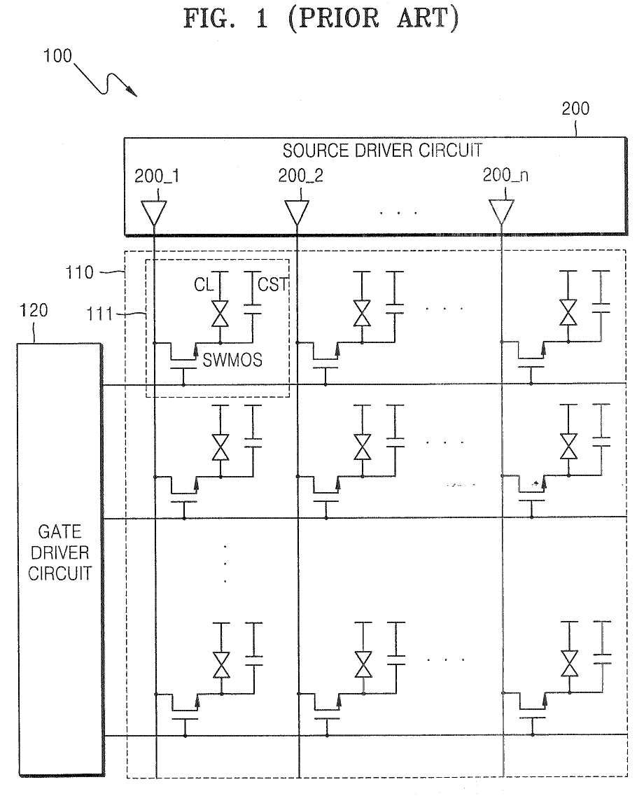

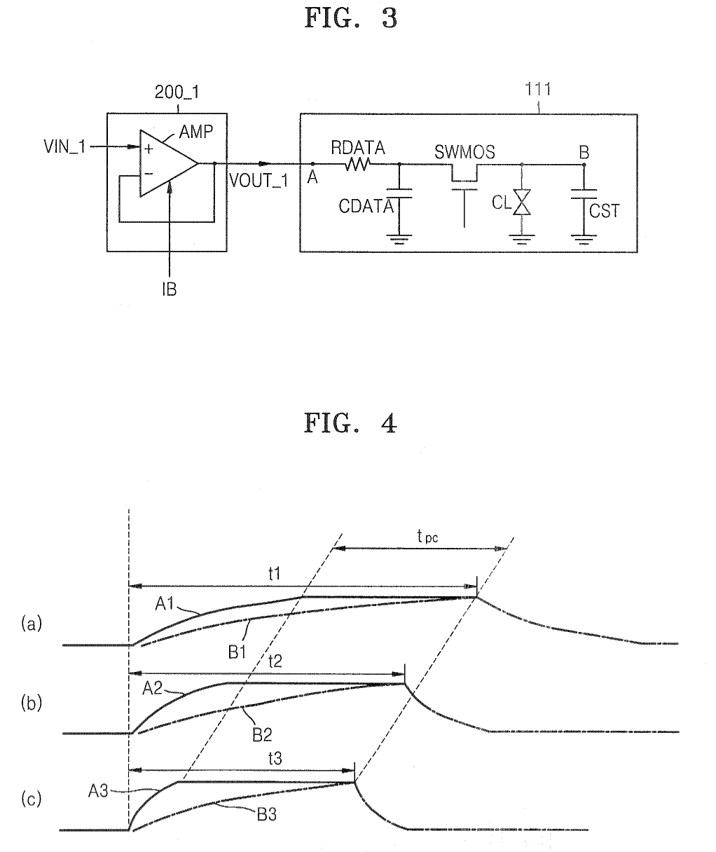

FIG. 3 is a circuit diagram in which the driver amplifier 200_1 of FIG. 2 and the liquid crystal cell 111 of a display panel of FIG. 1 are modeled.

In FIG. 3, A denotes a point at which the output voltage VOUT_1 of the driver amplifier 200_1 is applied to the liquid crystal cell 111, and B denotes a point at which the output voltage VOUT_1 of the driver amplifier 200_1 reaches a liquid crystal capacitor CL.

Referring to FIG. 3, after the output voltage VOUT_1 of the driver amplifier 200_1 is applied to the liquid crystal cell 11, the output voltage VOUT_1 is delayed by a predetermined time and then supplied to the liquid crystal capacitor CL. In this exemplary embodiment, an actual voltage supplied to the liquid crystal capacitor CL is the voltage at point B. Accordingly, in order to normally display gradation data, a voltage rising time at point B must be shorter than a time required for displaying the gradation data on the liquid crystal.

FIG. 4 shows timing diagrams illustrating voltage waveforms at the points A and B of FIG. 3.

Diagram (a) of FIG. 4 is a timing diagram illustrating voltage waveforms A1 and B1 at the points A and B when the frame frequency FF is at a low level. Diagram (b) of FIG. 4 is a timing diagram illustrating voltage waveforms A2 and B2 at the points A and B when the frame frequency FF is at an intermediate level between the low level and a high level. Diagram (c) of FIG. 4 is a timing diagram illustrating voltage waveforms A3 and B3 at the points A and B when the frame frequency FF is at the high level.

Referring to diagram (a) of FIG. 4, when the frame frequency FF is at the low level, a time t1 for which gradation data is displayed can be relatively long. Thus, a rising time of a voltage (the voltage at point B) supplied to the liquid crystal capacitor CL can be long. Accordingly, when the frame frequency FF is at the low level, the source driver circuit 200 reduces a slew rate of a voltage (the voltage at point A) applied to the liquid crystal cell 111, thereby reducing power consumption.

Referring to diagram (c) of FIG. 4, when the frame frequency FF is at the high level, a time t3 for which gradation data is displayed must be relatively short. Thus, a rising time of a voltage (the voltage at point B) supplied to the liquid crystal capacitor CL must also be short. Accordingly, when the frame frequency FF is at the high level, the source driver circuit 200 increases a slew rate of a voltage (the voltage at point A) applied to the liquid crystal cell 111, so that the gradation data can be normally displayed on the liquid crystal.

Referring to diagram (b) of FIG. 4, when the frame frequency FF is at the intermediate level, a time t2 for which gradation data is displayed is longer than the display time t3 of when the frame frequency FF is at the high level, and is shorter than the display time t1 of when the frame frequency FF is at the low level. Accordingly, when the frame frequency FF is at the intermediate level between the high level and the low level, the source driver circuit 200 adjusts a slew rate of a voltage (the voltage at point A) applied to the liquid crystal cell 111 to an intermediate value, thereby reducing power consumption while normally displaying the gradation data on the liquid crystal.

That is, the source driver circuit 200 adjusts a slew rate of an output voltage of a driver amplifier according to a frame frequency FF, thereby reducing power consumption while ensuring a time required for displaying gradation data.

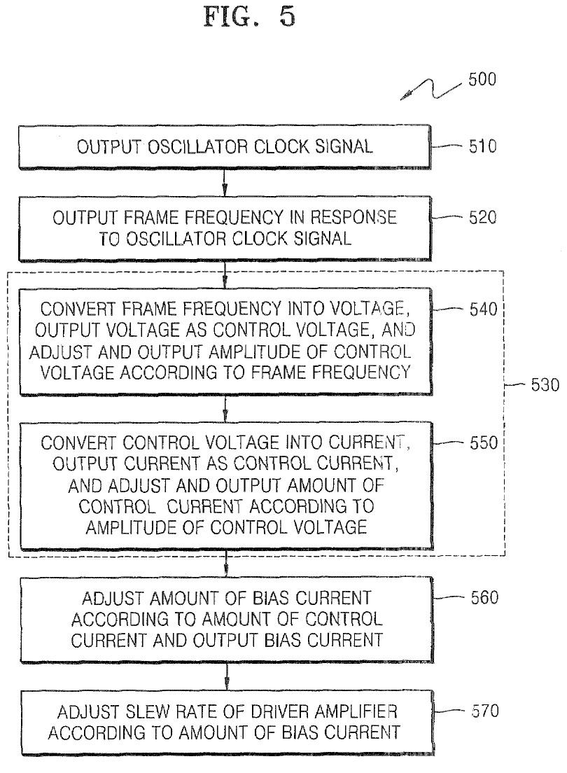

FIG. 5 is a flowchart illustrating a method 500 for controlling a slew rate according to a frame frequency in the source driver circuit 200, according to an exemplary embodiment of the present invention.

The slew rate control method 500, according to an exemplary embodiment of the present inventions includes: outputting a control current (operation 530); outputting a bias current (operation 560); and adjusting a slew rate of an output voltage of a driver amplifier (operation 570). In the step of outputting the control current (operation 530), a frame frequency is received and the control current having its amount adjusted according to the frame frequency is output. In the step of outputting the bias current (operation 560), an amount of the bias current is controlled according to the amount of the control current and the bias current is output. In the step of adjusting the slew rate of the output voltage of the driver amplifier (operation 570), the slew rate of the output voltage of the driver amplifier is adjusted according to the amount of the bias current.

The step of outputting the control current (operation 530) includes converting the frame frequency into a voltage, outputting the voltage as a control voltage and adjusting and outputting the amplitude of the control voltage according to the frame frequency (operation 540); and converting the control voltage into a current, outputting the current as the control current, and adjusting and outputting an amount of the control current according to the amplitude of the control voltage (operation 550).

The slew rate control method 500 shown in FIG. 5 can further include outputting the frame frequency (operation 520). Also, the slew rate control method 500 can further include outputting an oscillator clock signal (operation 510). In the step of outputting the frame frequency (operation 520), the frame frequency is output in response to the oscillator clock signal.

In the step of outputting the frame frequency (operation 520), the frame frequency can be output by counting the number of clocks of the oscillator clock signal included in one clock period of a vertical synchronization signal.

In this exemplary embodiment, the frame frequency can also be received from outside of the source driver circuit 200.

The slew rate control method 500 can further include outputting a frequency difference between a frame frequency and a reference frame frequency. In this case, in the step of outputting the control current (operation 530), a control current having an amount that is changed according to the frequency difference is output. In the step of outputting the bias current (operation 560), the reference bias current is summed with the control current and the summed result is output as the bias current. If the frame frequency is less than the reference frame frequency, the current control is subtracted from the reference bias current and the subtracted result is output as the bias current.

The slew rate control method 500 according to an exemplary embodiment of the present invention has the same technical concept as the source driver circuit 200 according to above-described exemplary embodiment of the present invention, and corresponds to the operation of the source driver circuit 200. Therefore, since the slew rate control method 500 according to the exemplary embodiment of the present invention can be understood by those skilled in the art from the above description, a detailed description thereof will be omitted,

As described above, in a source driver circuit and a method for controlling a slew rate in the source driver circuit, according to exemplary embodiments of the present invention, by adjusting a slew rate of an output voltage of a driver amplifier according to a frame frequency, it is possible to reduce power consumption while ensuring a time required for displaying gradation data.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A source driver circuit of a liquid crystal display apparatus comprising:
a plurality of driver amplifiers receiving a respective plurality of input voltages, generating a respective plurality of output voltages, and adjusting slew rates of the plurality of output voltages according to an amount of a bias current;
a frequency-current converting unit receiving a frame frequency and outputting a control current that is adjusted according to the frame frequency; and
a bias current outputting unit adjusting the bias current according to an amount of the control current and outputting the bias current to the plurality of driver amplifiers.

2. The source driver circuit of claim 1, wherein the frequency-current converting unit comprises:
a frequency-voltage converter converting the frame frequency into a voltages, outputting the converted voltage as a control voltage, and adjusting and outputting an amplitude of the control voltage according to the frame frequency; and
a voltage-current converter converting the control voltage into a current, outputting the current as the control current and adjusting and outputting an amount of the control current according to an amplitude of the control voltage.

3. The source driver circuit of claim 1, further comprising a frame frequency outputting unit outputting the frame frequency.

4. The source driver circuit of claim 3, further comprising an oscillator outputting an oscillator clock signal,
wherein the frame frequency outputting unit outputs the frame frequency in response to the oscillator clock signal.

5. The source driver circuit of claim 4, wherein the frame frequency outputting unit comprises a counter receiving a vertical synchronization signal and the oscillator clock signal, counting the number of clocks of the oscillator clock signal included in one clock period of the vertical synchronization signal, and outputting the frame frequency.

6. The source driver circuit of claim 3, wherein the source driver circuit is connected to a CPU interface.

7. The source driver circuit of claim 4, wherein the source driver circuit is connected to a CPU interface.

8. The source driver circuit of claim 5, wherein the source driver circuit is connected to a CPU interface.

9. The source driver circuit of claim 1, wherein the frame frequency is fed to the frequency-current converting unit from the outside.

10. The source driver circuit of claim 9, wherein the source driver circuit is connected to an RGB interface.

11. The source driver circuit of claim 1, further comprising a frequency comparator outputting a frequency difference between the frame frequency and a reference frame frequency,
wherein the frequency-current converting unit outputs a control current that changes according to the frequency difference, and
the bias current outputting unit sums a reference bias current with the control current and outputs the sum as the bias current.

12. The source driver circuit of claim 11, wherein the bias current outputting unit,
sums the reference bias current with the control current and outputs the sum as the bias current, when the frame frequency is greater than the reference frame frequency, and
subtracts the control current from the reference bias current and outputs the difference as the bias current, when the frame frequency is less than the reference frame frequency.

13. A method for controlling a slew rate in a source driver circuit, comprising:
receiving a frame frequency and outputting a control current that is adjusted according to the frame frequency;
adjusting an amount of a bias current according to an amount of the control current and outputting the bias current, and
adjusting a slew rate of an output voltage of a driver amplifier according to the amount of the bias current.

14. The method of claim 13, wherein the step of outputting the control current comprises:
converting the frame frequency into a voltage, outputting the voltage as a control voltage, and adjusting and outputting an amplitude of the control voltage according to the frame frequency; and
converting the control voltage into a current, outputting the current as the control current, and adjusting and outputting the amount of the control current according to the amplitude of the control voltage.

15. The method of claim 13, further comprising outputting the frame frequency.

16. The method of claim 15, further comprising outputting an oscillator clock signal,
wherein, in the step of outputting the frame frequency the frame frequency is output in response to the oscillator clock signal.

17. The method of claim 16, wherein the step of outputting the frame frequency comprises receiving a vertical synchronization signal and the oscillator clock signal, counting the number of clocks of the oscillator clock signal included in one clock period of the vertical synchronization signal, and outputting the frame frequency.

18. The method of claim 15, further comprising connecting the source driver circuit to a CPU interface.

19. The method of claim 13, further comprising receiving the frame frequency from the outside of the source driver circuit.

20. The method of claim 19, wherein the source driver circuit is connected to an RGB interface.

21. The method of claim 13, further comprising outputting a frequency difference between the frame frequency and a reference frame frequency,
wherein, in the step of outputting the control current, the control current that is changed according to the frequency difference is output, and
in the step of outputting the bias current, a reference bias current is summed with the control current and the sum is output as the bias current.

22. The method of claim 21, wherein in the step of outputting the bias current,
when the frame frequency is greater than the reference frame frequency, the reference bias current is summed with the control current and the sum is output as the bias current, and
when the frame frequency is less than the reference frame frequency, the control current is subtracted from the reference bias current and the difference is output as the bias current.
